(19) United States
(12) Patent Application Publication
(10) Pub. No.: US 2026/0326013 A1
(43) Pub. Date: Oct. 22, 2026

(54) Air Pressuriser

(71) Applicant: Work Air Technologies Pty Ltd, Wangara (AU)

(72) Inventor: Greg Brian Knowles, Ashby (AU)

(73) Assignee: Work Air Technologies Pty Ltd, Wangara, WA (AU)

(21) Appl. No.: 19/109,705

(22) PCT Filed: Sep. 8, 2023
(86) PCT No.: PCT/AU2023/050872

§ 371 Date: Mar. 7, 2025

(30) Foreign Application Priority Data
Sep. 9, 2022 (AU) 2022902610

(51) Int. Cl. B01D 50/20; B01D 45/16; B01D 46/00; B01D 46/24; B01D 46/44; B01D 46/46; B01D 46/58; B04C 9/00

(52) U.S. Cl. CPC B01D 50/20; B01D 45/16; B01D 46/0047; B01D 46/24; B01D 46/448; B01D 46/46; B01D 46/58; B04C 9/00; B01D 2279/50; B04C 2009/002; B04C 2009/005

(57) ABSTRACT

An air pressuriser comprising: at least one centrifugal separator having a filtered air exhaust port and a filtered particle exhaust port; at least one filter; a suction device; and a pressurisation fan. Each of the aforementioned components is housed in at least one housing. The pressurisation fan applies a suction force to the filtered air exhaust port by way of at least one of the at least one filters. The suction device applies a corresponding suction force to the filtered particle exhaust port. The amount of corresponding suction force being applied is at least of sufficient force to compensate for any difference between the velocity of air flow passing through the at least one centrifugal separator and the velocity of air flow required by the at least one centrifugal separator to effect centrifugal separation of particles from the air flow.

### FIELD OF THE INVENTION

The invention relates to an air pressuriser.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Air pressurisers are commonly used in HVAC systems as a means of preventing airborne dust particles, such as silica or asbestos, from entering into an enclosed environment. To assist in this aim, pressurisers often incorporate filtration systems.

A problem with existing air pressurisers is that the primary filtration means is often a centrifugal separator (otherwise known as a cyclonic separator). If air directed through the centrifugal separator is below a threshold operating level, the filtration efficiency may be severely compromised. For this reason, a pressurisation fan may be used to draw air through the centrifugal separator by way of the filtered air exhaust port.

The problem with this solution is that if other filters are interspersed between the centrifugal separators and the pressurisation fan, the drawing force of the pressurisation fan may be compromised to the point where it has no additional beneficial effect on the centrifugal separators. This is likely to be the case in situations where the interspersed filters are blocked by particles that have not been able to be separated by the centrifugal separator at first instance.

It is therefore an object of the present invention to provide an alternative method of pressurising air that avoids, or ameliorates at least in part, one or more fo the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is an air pressuriser comprising:
at least one centrifugal separator having a filtered air exhaust port and a particle exhaust port;
at least one filter;
a suction device; and
a pressurisation fan,
where each of the aforementioned components is housed in at least one housing and where the pressurisation fan is operable to apply a suction force to the filtered air exhaust port by way of at least one of the at least one filters and the suction device operable to apply a suction force to the particle exhaust port, the amount of suction force being applied to the particle exhaust port being at least of sufficient force to compensate for any difference between the velocity of air flow passing through the at least one centrifugal separator and the velocity of air flow required by the at least one centrifugal separator to effect centrifugal separation of particles from the air flow.

The at least one centrifugal separator and the suction device may be located in a first housing connected to, but separable from, the housing, or housings, in which the at least one filter and pressurisation fan are housed. This first housing is, preferably, divided into an upper chamber and a lower chamber, the at least one centrifugal separator being located in the upper chamber and the interior of the upper chamber having at least one angled wall to funnel particles separated by the at least one centrifugal separator to the lower chamber.

The suction device may be a conduit leading to a vacuum source. Alternatively, the suction device may be a fan.

A mounting structure may operate to further divide the upper chamber from the lower chamber, the vacuum source being maintained in its desired position with the first source by way of the mounting structure. Additionally, the lower chamber may have a bottom exhaust vent and at least one side exhaust vent.

The at least one filter is, preferably, located in a second housing connected to, but separable from, the remaining housings, and where the second housing has a dividing wall that divides the second housing into an upper chamber and a lower chamber and where the upper chamber, in cross-section, being of different shape to the lower chamber.

The lower chamber may be sized so as to receive a portion of a lower cylindrical filter having a first flange about its periphery, the first flange spaced from an end of the lower cylindrical filter, the cross-sectional shape of the first flange being substantially identical to the cross-sectional shape of the lower chamber. Similarly, the upper chamber may be sized so as to receive a portion of an upper cylindrical filter having a second flange about its periphery at a first end of the upper cylindrical filter, the cross-sectional shape of the second flange being substantially identical to the cross-sectional shape of the upper chamber.

The pressuriser may be located in a third housing connected to, but separable from, the remaining housings, and where the third housing has an upper circular aperture and a lower circular aperture, the pressuriser being received within the third housing by way of the lower circular aperture. A scroll wall may surround a portion of the periphery of the lower circular aperture, the scroll wall deflecting at one end towards the upper circular aperture.

The upper circular aperture may have a locating lip for positioning a second end of the upper cylindrical filter.

The air pressuriser may also include a mid-plate, the mid-plate connected to, but separable from, the first housing, and where the mid plate has a first circular aperture for receiving a portion of the lower cylindrical filter including the end and where the interior of the mid-plate defines a conduit between the filtered air exhaust port and the lower cylindrical filter.

The air pressuriser may also include a cover plate having an upper portion and a lower portion, the upper portion having at least one opening provided therein, each opening being coaxially aligned with an inlet port of each of the at least one centrifugal separators. Each opening is, preferably, surrounded by a funnel ring. The lower portion may include an identification plate.

The suction device may be powered by a stored power system. Alternatively, each housing may have at least one electrical connection, each electrical connection able to matedly connect with the electrical connection of its adjacent housings so as to provide a power source for the suction device.

Each housing may be connected to its adjacent housings by way of a locking arrangement comprising a pivotable locking arm and a lug. In one variation, the pivotable locking arm is biased towards the lug.

The upper cylindrical filter may be a HEPA filter. The lower cylindrical filter may be one of the following: a HEPA filter; a SO₄ filter; a CO₂ filter.

The speed of the fan may be controlled by a fan controller. In a further variant, the fan controller is operable to control the speed of the fan based on the temperature measured by a temperature sensor.

In another variant, each of the at least one centrifugal separators is removable.

In accordance with a second aspect of the present invention there is a method of pressurising air comprising the steps of:
applying a suction force generated by a pressurisation fan to a filtered air exhaust port of at least one centrifugal separator, the suction force being applied to the filtered air exhaust port by way of at least one filter;
applying a suction force generated by a suction device to a filtered particle exhaust port of the at least one centrifugal separator; and
ensuring that the amount of suction force generated by the suction device to the filtered particle exhaust port is sufficient to compensate for any difference between the velocity of air flow passing through the at least one centrifugal separator and the velocity of air flow required by the at least one centrifugal separator to effect centrifugal separation of particles from the air flow.

The method may further comprising the steps of:
funnelling the particles separated by the at least one centrifugal separator to a lower chamber of a first housing in which the at least one centrifugal separator and the suction device are located; and
expelling the particles from the first housing by way of exhaust vents.

The exhaust vents are, preferably, located in the bottom and at least one side of the lower chamber.

The suction device may be a conduit leading to a vacuum source. Alternatively, the suction device may be a fan.

The method may also include the step of controlling the speed of the fan. In a variation of this configuration, the method includes the step of measuring the atmospheric temperature and setting the speed of the fan based on the atmospheric temperature measurement.

### BRIEF DESCRIPTION OF THE DRAWINGS

The invention will now be described, by way of example only, with reference to the accompanying drawings, in which:

FIG. 1 is a perspective view of an air pressuriser according to the present invention.

FIG. 2 is a perspective view of a cover plate as shown in FIG. 1.

FIG. 3 is a partial exploded view of a cyclonic filtration chamber housing as shown in FIG. 1 along with the cover plate as shown in FIG. 2.

FIGS. 4a and 4b are a plan and cross-sectional view of a filter as used in the cyclonic filtration chamber housing shown in FIG. 3.

FIG. 5 is a perspective view of a mid-plate as shown in FIG. 1.

FIG. 6 is a perspective view of a cartridge filtration chamber housing as shown in FIG. 1.

FIG. 7 is a perspective view of a lower filter as housed within the cartridge filtration chamber housing as shown in FIG. 6.

FIG. 8 is a perspective view of a pressuriser housing as shown in FIG. 1.

FIG. 9 is an exploded view of the air pressuriser as shown in FIG. 1.

### PREFERRED EMBODIMENTS OF THE INVENTION

In accordance with a first embodiment of the invention there is an air pressuriser 10. The air pressuriser 10 will be described in the context of its intended use as part of a vehicle air conditioning system, but the pressuriser is not in any way limited to such use.

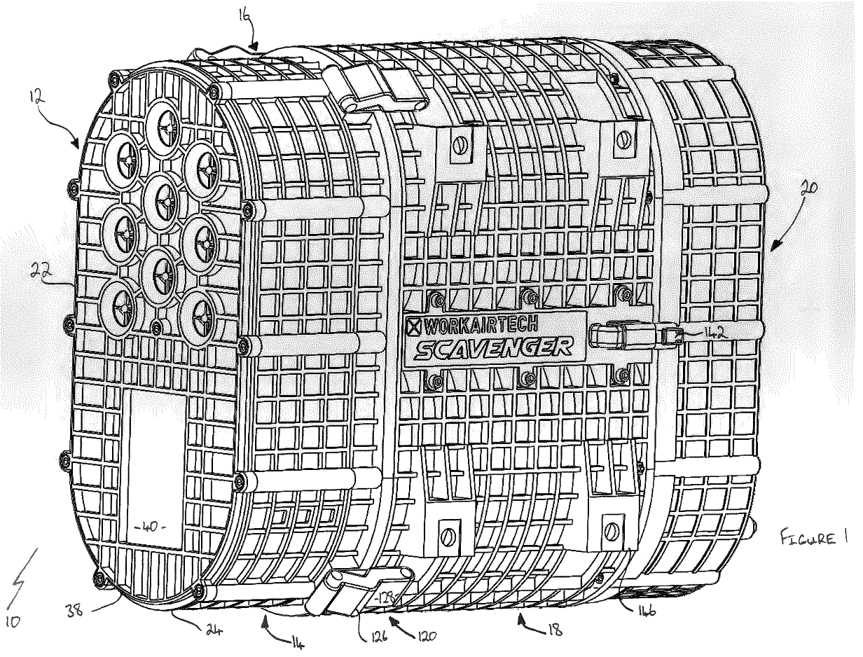

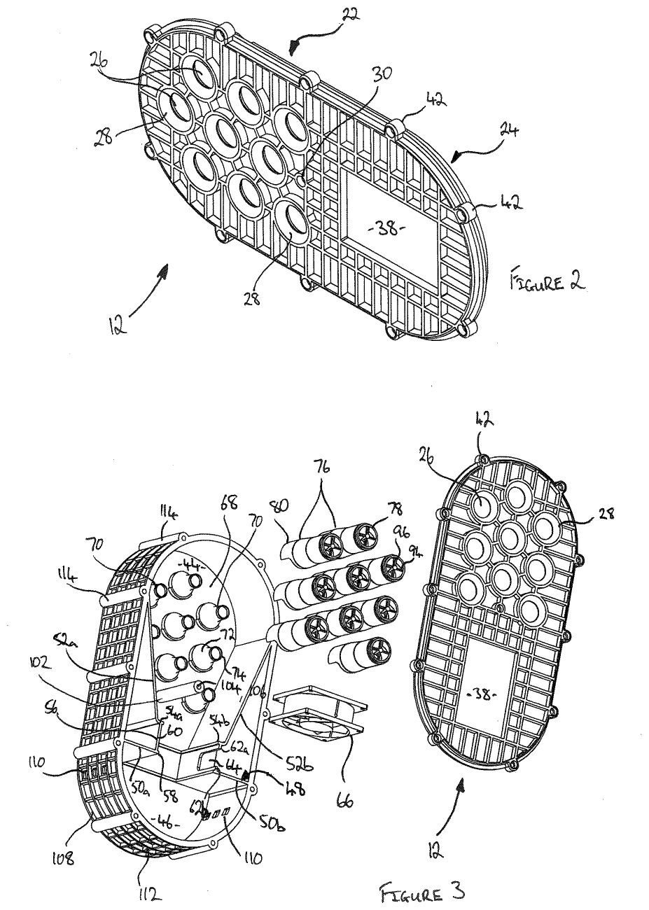

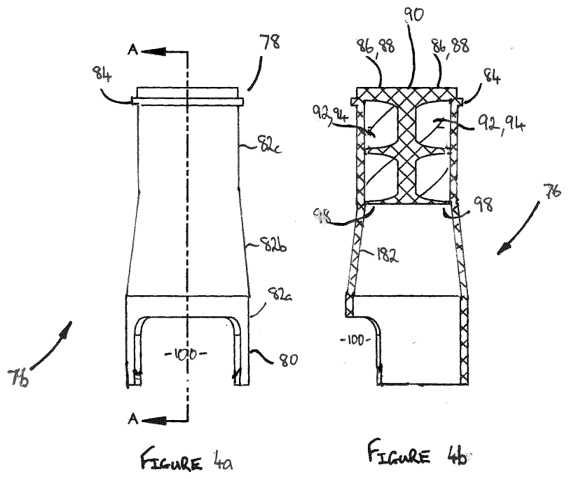

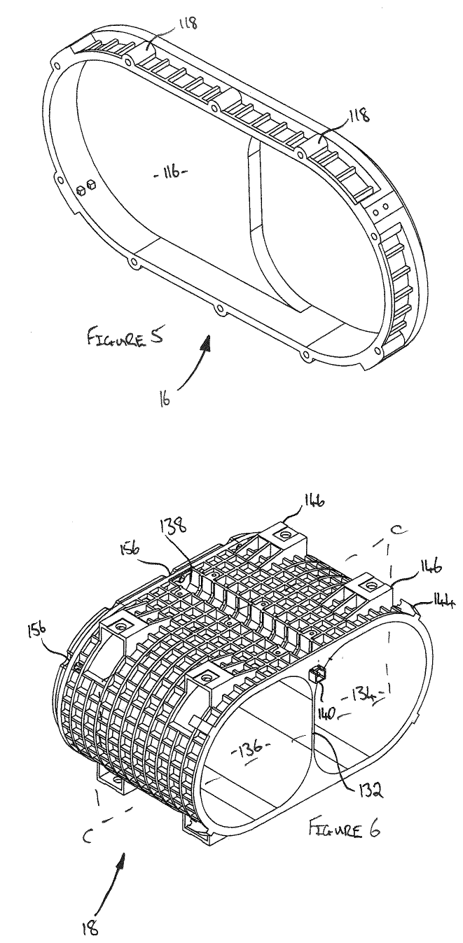

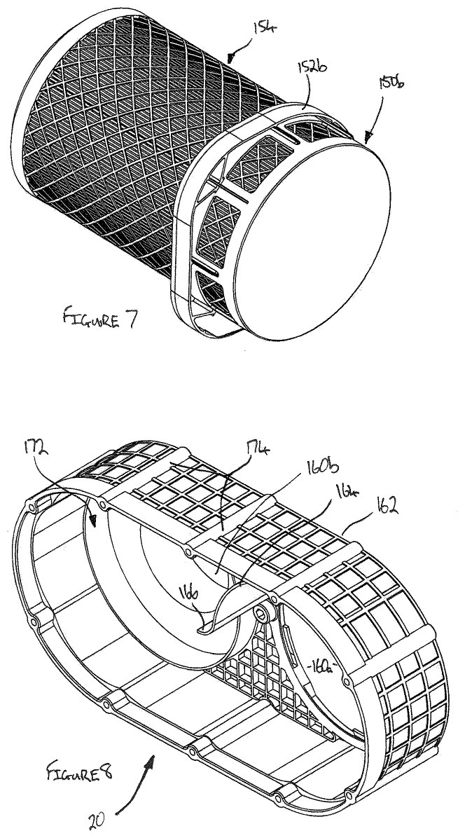

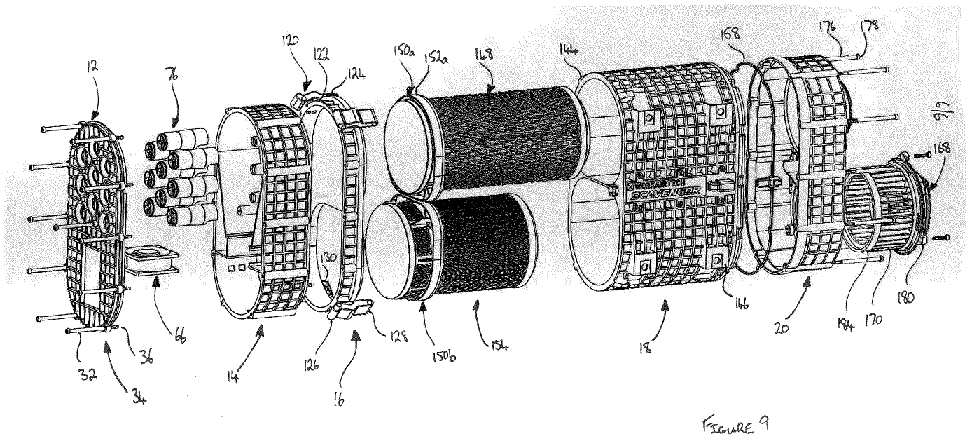

The air pressuriser 10 as shown in FIG. 1 comprises a cover plate 12, a cyclonic filtration chamber housing 14, a mid-plate 16, a cartridge filtration chamber housing 18 and a pressuriser housing 20.

The cover plate 12 has an upper portion 22 and a lower portion 24. The upper portion 22 has a plurality of through openings 26 provided therein. Each through opening 26 is surrounded by a funnel ring 28.

The cover plate 12 has a bolt recess 30 located proximate the lower portion 24. The bolt recess adapted to receive a head 32 of a bolt 34 without allowing it to pass therethrough. The bolt 34 has an elongated smooth portion and a threaded end 36.

The lower portion 24 is gridded except for a central rectangular recess 38. The central rectangular recess 38 accommodates an identification plate 40.

Located about the periphery of the cover plate 12 are a plurality of bolt recesses 42. Each bolt recess 42 is identical to bolt recess 30 and accommodates a bolt 34 in the same manner.

The cyclonic filtration chamber housing 14 is divided into a cyclonic filtration chamber 44 and an air exhaust chamber 46. The cyclonic filtration chamber 44 is partially divided from the air exhaust chamber 46 by way of a fan mounting structure 48.

The fan mounting structure 48 comprises a left fan mounting structure 48a and a right fan mounting structure 48b. The left fan mounting structure 48a comprises a perpendicular wall 50a and an angled wall 52a. The angled wall 52a terminates in a lip 54a that extends from the angled wall 52a in a direction parallel to the perpendicular wall 50a. A connecting wall 56 extends between the lip 54a and perpendicular wall 50a at a position spaced from the ends 58 of each. In this manner, the combination of the connecting wall 56 and ends 58 define a shallow locating channel 60.

The right fan mounting structure 48b comprises a perpendicular wall 50b and an angled wall 52b. The angled wall 52b terminates in a lip 54b that extends from the angled wall 52b in a direction parallel to the perpendicular wall 50b. A first retaining projection 62a extends perpendicular from the lip 54b towards the perpendicular wall 50b. Similarly, a second retaining projection 62b extends perpendicular from the perpendicular wall 50b towards the lip 54b. In this manner, the space between the retaining projections 60 define a retaining opening 64.

The distance between the shallow locating channel 60 and the retaining opening 64 is substantially the same as the width of a fan 66. Similarly, the depth of the cyclonic filtration chamber housing 14 is substantially the same as the length of the fan 66.

The fan 66 is a square fan of similar construction used to cool computer cases. In this manner, the fan 66 draws power by way of a three-pin connector (not shown).

The cyclonic filtration chamber 44 has a blocking wall 68. Extending from the blocking wall 68 are a plurality of filter mounts 70. The filter mounts 70 are arranged in the same pattern as the through openings 26. The blocking wall 68 also has a plurality of airflow apertures (not shown) provided therein.

Each filter mount 70 comprises a hollow mount base 72 and a hollow projection 74. The projection 74 and the mount base 72 have a circular lateral cross-section. The projection 74 extends centrally from the mount base 72 at a position corresponding with an airflow aperture. In this manner, the projection 74 and the mount base 72 are concentrically aligned. Furthermore, the combination of hollow mount base 72 and hollow projection 74 acts as a conduit to the airflow aperture.

Each filter mount 70 is designed to facilitate the retention of a removable filter 76. The removable filter 76 is shown in FIGS. 3a and 3b.

The filter 76 has a face plate end 78 and a base end 80. The filter 76 is separated into three segments 82a, 82b, 82c as it extends from the base end 80 to the face plate end 78. Segments 82a and 82c are aligned in parallel planes. Segment 82b tapers as it extends from segment 82a to segment 82c. In this manner, the filter 76 can be considered to have a slight inward taper as it extends from the base end 80 towards the face plate end 78. This also means that both the face plate end 78 and the base end 80 are coaxial aligned about axis A-A, but base end 80 is of larger diameter than face plate end 78.

A positioning lip 84 extend about the circumference of the filter 76 at a position just short of the face plate end 78. In this embodiment, the distance between the positioning lip 84 and the face plate end 78 is equal to the thickness of the through opening 26.

The face plate end 78 of this embodiment is divided into four quadrants 86. Each quadrant 86 is separated from its adjacent quadrants 86 by crossbeams 88 that extends to a circular hub 90.

The crossbeams 88 and the circular hub 90 extends back towards the base end 80 to a point in general alignment with the lip 84.

Each quadrant 86 incorporates a curved downwardly sloping wall 92 provided therein. The wall 92 extends the full length of clockwise crossbeam 94 and the portion of the circular hub 90 that faces the quadrant 86. The wall 92 extends only partially along anti-clockwise crossbeam 96. In this manner, the wall 92 slopes downwards in an anti-clockwise direction until it reaches air inlet 98 creating something that is similar to a fan of static position.

A cut-away 100 is provided in the base end 80. In this embodiment, the highest point of the cut-away 100 is higher than the height of the mount base 72.

Also located within the cyclonic filtration chamber 44 is an elongate cover projection 102. The cover projection 102 extends from the blocking wall 68 but is not of a depth that allows the cover projection 102 to protrude from the cyclonic filtration chamber 44. The cover projection 102 has a threaded aperture 104 provided centrally in its unconnected end 106. The threaded aperture 104 is sized so as to receive the threaded end 36 of a bolt 34. The threaded aperture 104 is in axial alignment with bolt recess 30.

The air exhaust chamber 46 is hollow. Located in the outer wall 108 of the cyclonic filtration chamber housing 14 are side exhaust vents 110 and bottom exhaust vents 112. The role of the exhaust vents 110, 112 will be explained in more detail below.

Located on an external surface of the outer wall 108 are a plurality of first bolt tunnels 114. Each first bolt tunnel 114 is in axial alignment with a bolt recess 42.

An electrical contact (not shown) is attached to the blocking wall 68 and the inner surface of the outer wall 108. The electrical contact has a fan side and a filter side. The fan side provides a mating electrical interface for the three-pin connector. The filter side has a mating electrical interface for a power connector (not shown).

A mounting wall 116 covers part of the interior of the mid-plate 16 (approximately mid-length thereof). Located about the periphery of the mid-plate 16 are threaded apertures 118. Each threaded aperture 118 is in axial alignment with a first bolt tunnel 114 and a bolt recess 42.

Also located about the periphery of the mid-plate 16 are a plurality of locks 120. Each lock 120 comprises a pivot mount 122 and a locking arm 124. The pivot mount 122 is fixedly connected to the periphery of the mid-plate 16. The locking arm 124 is pivotally connected to the pivot mount 122.

A section 126 of the locking arm 124 that extends back towards the cover plate 12 operates as an actuator. The other section 128 of the locking arm 124 acts as a retention mechanism. The actuator 126 is biased away from the cyclonic filtration chamber housing 14. In doing so, by reason of its pivotal connection to the pivot mount 122, the retention mechanism 128 is similarly biased towards the cartridge filtration chamber housing 18.

The retention mechanism 128 has a square aperture 130 provide therein. The square aperture 130 does not extend all the way through the retention mechanism 128.

The interior of the cartridge filtration chamber housing 18 is divided by a dividing wall 132 to form an upper chamber 134 and a lower chamber 136 of different cross-sectional shapes when taken along the C-C plane. The dividing wall 132 thickens to one side to create a triangular recess having a covered conduit 138 extending therethrough. One end of the covered conduit 138 terminates at a mating electrical interface 140 for a power connector. The other end of the covered conduit 138 also terminates in a mating electrical interface 142 for a power connector. However, mating electrical interface 142 is located, but connected to, the exterior to the cartridge filtration chamber housing 18.

Located about the exterior of the cartridge filtration chamber housing 18 are a plurality of lugs 144. Each lug 144 is of size and shape as to fit within square aperture 130. In the same manner, each lug 144 is positioned so as to align with a lock 120.

Also located about the exterior of the cartridge filtration chamber housing 18 are a plurality of mounting recesses 146. As the mounting recesses 146 are peripheral to this invention, and would be readily known to the person skilled in the art, they will not be described in more detail here.

The upper chamber 134 is adapted to receive a cylindrical upper filter 148. The upper filter 148 has a first end cap 150a attached at one end. The end cap 150a has a shaped flange 152a extending about its periphery. When viewed along the C-C axis, the cross-sectional shape of the shaped flange 152a matches the cross-sectional shape of the upper chamber 134.

Similarly, the lower chamber 136 is adapted to receive a cylindrical lower filter 154. The lower filter 154 has a second end cap 150b attached at one end. The second end cap 150b has a shaped flange 152b extending about, and spaced from, its periphery. When viewed along the C-C axis, the cross-sectional shape of the shaped flange 152b matches the cross-sectional shape of the lower chamber 134.

Located in the periphery of the cartridge filtration chamber housing 18 at the end facing the pressuriser housing 20 are a plurality of threaded apertures 156 and a recessed sealing groove (not shown). The recessed sealing groove is adapted to receive seal 158.

The pressuriser housing 20 is also hollow. The pressuriser housing 20 has two circular apertures 160 provided in an end wall 162. Circular aperture 160a is of significantly larger diameter than circular aperture 160b. In contrast, circular aperture 160b is of greater depth than circular aperture 160a. A scroll wall 164 surrounds part of circular aperture 160a. An end 166 of the scroll wall 164 deviates towards a pressurisation fan 168 when installed, before deflecting back towards circular aperture 160b.

The depth of the pressuriser housing 20 is substantially equal to the depth of the pressurisation fan 168. Body 170 of the pressurisation fan 168 is adapted to pass through circular aperture 160a to be received within lower chamber 134.

Surrounding circular aperture 160b is a circular locating recess 172. The diameter of the circular locating recess 172 is just slightly larger than the diameter of the cylindrical upper filter 148.

Located on an external surface of the outer wall of the pressuriser housing 20 are a plurality of second bolt tunnels 174. Each second bolt tunnel 174 is in axial alignment with a threaded aperture 156. In this manner, a bolt 176 of identical construction to bolt 34 may be received in both the second bolt tunnel 174 and the threaded aperture 156. The bolt head 178, being larger than the aperture of the bolt tunnel 174, prevents the bolt 176 from being drawn fully therein.

The assembly and operation of this embodiment of the invention will now be described.

To assemble the air pressuriser 10, the body 170 of the pressurisation fan 168 is passed through circular aperture 160a to be received within lower chamber 134. The pressurisation fan 168 is then secured in this position using an appropriate securing mechanism. In this example, the securing mechanism takes the form of locating pins 180. It is to be noted that the body 170 of the pressurisation fan 168 extends substantially the full depth of the pressuriser housing 20.

The seal 158 is then press fitted into the recessed sealing groove. Once so fitted, the pressuriser housing 20 can be secured to the cartridge filtration chamber housing 18.

Securing the pressuriser housing 20 to the cartridge filtration chamber housing 18 involves aligning the pressuriser housing 20 such that the pressurisation fan 168 is aligned with the lower chamber 136. The position of the pressuriser housing 20 is further adjusted to ensure that each of the second bolt tunnels 174 axially aligns with a threaded aperture 156. Once so aligned, bolts 176 are inserted through the second bolt tunnel 174 and manipulated such that the threaded end 36 of the bolt 176 threadedly engages the threaded aperture 156. This threaded engagement causes the pressuriser housing 20 to abut the cartridge filtration chamber 18, with the seal 158 operating to prevent leakage at this point of connection.

The lower filter 154 is then installed into the lower chamber 136 and pushed in the direction of the pressurisation fan 168 until it makes contact with same. To facilitate contact between the pressurisation fan 168 and the lower filter 154, the pressurisation fan 168 has a circular positioning lip 184. The circular positioning lip 184 is of only slightly larger diameter than the diameter of the lower filter 154, so that the circular positioning lip 184 encircles part of the lower filter 154 when correctly installed.

For the lower filter 154 to make contact with the pressurisation fan 168, the second end cap 150b must also be rotated until its cross-sectional profile matches that of the lower chamber 136. In this manner, when received within the lower chamber 136, the second end cap 150b also assists with proper axial alignment of the lower filter 154.

The upper filter 148 is then installed into the upper chamber 134 and pushed in the direction of the circular locating recess 172 until it makes contact with same. It is to be noted that due to the extended length of the upper filter 148 relative to the lower filter 154, the upper filter 148 extends through the whole of the upper chamber 134 into the pressurisation chamber 20.

In a manner similar to installation of the lower filter 154, in order for the upper filter 148 to make contact with the circular locating recess 172, first end cap 150a must be rotated until its cross-sectional profile matches that of the upper chamber 134. Again, the nature of the first end cap 150a-along with the matching diameter of the upper filter 148 to the diameter of the circular locating recess 172 assist in the proper axial alignment of the upper filter 148.

It is to be noted that while the cross-sectional shape of first end cap 150a and second end cap 150b are identical, the second end cap 150b is configured such that the shaped flange 152 is positioned partly along its attached filter 148. In this manner, there can be no confusion between which filter 148, 154 as incorrect installation will not allow the mid-plate 16 to be properly attached to the cylindrical filtration chamber housing 18. Additionally, the shape of the end caps 150a, 150b only allows for correct installation of the attached filters 148, 154 in a single orientation.

With the filters 148, 154 installed, the mid-plate 16 is positioned so as to align with the end caps 150a, 150b. Once aligned, the mid-plate 16 is pushed towards the filters 148, 154. This results in the end cap 150b and mating electrical interface 140 passing through the interior of the mid-plate 16, while the end cap 150a abuts the mounting wall 116. This also results in the portion of the lower filter 148 between the second end cap 150b and the shaped flange 152 extending therethrough.

To secure the mid-plate 16 in this position, the user simultaneously applies pressure to the actuator 126 so as to move each towards the interior of the mid-plate 16. By doing so, the locking arm 124 pivots about the pivot mount 122 with the end result that the retention mechanism 128 is similarly biased away from the cartridge filtration chamber housing 18.

Specifically, the retention mechanism 128 is moved at least a distance away from the cartridge filtration chamber housing 18 greater than the height that the lugs 144 extend from the exterior of the cartridge filtration chamber housing 18. This allows each retention mechanism 128 to pass over the lugs 144 before the pressure applied to the actuator 126 is released. Once released, the lug 144 is received within the square aperture 130 and thus contained. It is this containment of the lug within the square aperture 130 that secures the mid-plate 16 to the cartridge filtration chamber housing 18.

The cyclonic filtration chamber housing 14 is then positioned next to the mid-plate 16. The cyclonic filtration chamber housing 14 is then manipulated until such time as:
One side of the mating electrical interface located in the cyclonic filtration chamber housing 14 forms a secure electrical connection with mating electrical interface 140; and
Each of the first bolt tunnels 114 is axially aligned with a threaded aperture 118.

Fan 66 is then installed into the fan mounting structure 48. This Installation involves aligning opposing sides of the fan 66 with the shallow locating channel 60 and the clamping opening 64. The fan 66 is then pushed towards the blocking wall 68. In doing so, the clamping projections 62a, 62b are forced apart from one another until such time as the fan 66 abuts the blocking wall 68. At that time, the clamping projections seek to return to their normal position. As the fan 66 now takes up this position, this results in the clamping projections 62a, 62b applying a clamping force to the fan 66 which keeps the fan 66 in this position.

It is important to note that the fan 66, is to be arranged such that the fan 66 draws air from the cyclonic filtration chamber 44 and expels air into the air exhaust chamber 46.

The three-pin connector of the fan 66 is then connected to the unconnected side of the mating electrical interface located in the cyclonic filtration chamber housing 14.

Filters 76 are then installed. To install a filter 76, the base end 80 is aligned with a hollow mount base 72. The base end 80 is then pushed towards the blocking wall 68, such that an interference fit is formed between the interior of the filter 76 and the hollow mount base 72.

With the filters 76 and fan 66 installed, the cover plate 12 may then be installed. The cover plate 12 is manipulated until such time as:
Each opening 26 is co-axially aligned with the face plate end 78 of a filter 76;
Each of the bolt recesses 42 is co-axially aligned with a first bolt tunnel 114 and a threaded aperture 118; and
The bolt recess 30 is co-axially aligned with threaded aperture 104 of elongate cover projection 102.

The cover plate 12 is then secured in this position by a plurality of bolts 34. Each bolt 34 is inserted through bolt recesses 42 into the first bolt tunnel 114 and the threaded aperture 118. The bolt 34 is then manipulated such that the threaded end 36 threadedly engages the threaded aperture 118. This threaded engagement causes the cover plate 12 to abut the cyclonic filtration chamber housing 14 and draw both into physical connection with the mid-plate 16.

In operation, an electrical connection is formed between an external power source (not shown) and mating electrical interface 142. This allows electrical power to flow through the mating electrical interfaces 140, 142 and conduit 138 to ultimately provide power to the fan 66 by way of the three-pin connector.

When powered, the fan 66 operates to draw air from the cyclonic filtration chamber 44. As part of this, the fan 66 also applies a suction force to draw air through the filters 76 by way of cut aways 100.

This suction force applied by the fan 66 assists in situations where an air stream directed towards the openings is of insufficient speed for the filter 76 to effect proper cyclonic separation of particles therefrom or where the suction force applied to the filter 76 by the pressurisation fan 168 (by way of the airflow apertures in the blocking wall 68 and lower filter 154). To put it another way, when powered, the fan 66 is always applying a suction force to the filters 76 that ensures that air flows through the filter 76 at a velocity sufficient to facilitate proper cyclonic separation of particles from the directed airstream.

As the through opening 26 creates an air tight seal against the positioning lip 84, no air enters the pressuriser 10 other than by way of the filters 76. To assist in directing the largest quantity of air to the filter 76, the funnel rings 28 act as a bell mouth for the filter 76. Air directed by the funnel ring 28 in this manner is channelled towards the curved downwardly sloping wall 92 of a quadrant 86.

Each curved downwardly sloping wall 92 directs the air in a manner that an anti-clockwise vortex is formed in the area between the filter 76 and the projection 74 by reason of its velocity prior to entry into the funnel ring or by reason of the additional suction force applied by the fan 66 (or a combination of the two). This anti-clockwise vortex applies a centrifugal force against any contaminants within the air. This ensures that the contaminants are pushed towards inner wall 182 of the filter 76, while the remaining, purified air is drawn through the projection 74 towards the mid-plate 16.

The centrifugal force generated by the anti-clockwise vortex, as assisted by the suction force applied by the fan 66, draws the contaminants towards cut away 100. When the contaminants reach the cut away opening 100, they are expelled into the open area of the cyclonic filtration chamber 44.

It is to be noted that as the filters 76 expands slightly from the face plate end 78 to the base 80, so too does the inner wall 182. As a result, the Venturi effect operates to reduce the velocity of the particles contained in the anti-clockwise vortex prior to their expulsion through the cut away 100. This reduction in velocity also operates to disperse the entrained particles.

As mentioned above, the particles separated by each filter 76 are drawn out through its cut away 100 to pass through the fan 66 into the air exhaust chamber 46. Following entry into the air exhaust chamber 46, the particles are ultimately discharged into the pressuriser's 10 surrounding environment by way of vents 110, 112.

The filtered airstream is expelled towards mounting wall 116 where the mounting wall 116 and the blocking wall 68 operate to channel it towards the end cap 150b of the lower filter 154. As already indicated, the spacing of the shaped flange 152b in this end cap 150b means that part of the lower filter 154 acts as a choke point for the channelled airflow. Thus, the channelled airflow is always drawn through the lower filter 154 by the suction force generated by the pressurisation fan 168.

The pressurisation fan 168 ensures that the channelled airflow is pressurised to at least a pre-determined pressure level (whether by increasing the pressure level of the airflow or maintaining the current pressure level). This pressurised airflow is then directed towards the upper filter 148 by way of scroll wall 164.

The pressurised airflow that is directed towards the upper filter 148 is ultimately directed out of the pressuriser 10 by way of circular aperture 160b for further use by the system in which the pressuriser 10 is installed.

It is to be noted here that the pressuriser 10 incorporates mounting recesses 146. These mounting recesses 146 allow the pressuriser to be mounted either vertically or horizontally as space requirements and the layout or other components of the system in which the pressuriser 10 is installed dictate. In this respect, the use of the two vents 110, 112, ensure that-regardless of the mounting arrangement of the pressuriser 10, the air exhaust chamber 46 always has at least one vent 110, 112 in its lower wall and in its exterior side wall.

Additionally, the modularised nature of this pressuriser 10 means that multiple cartridge filtration chamber housings 18 may be installed in series, each being interconnected through locks 120. As the flow path of air filtered from the cyclonic filtration chamber housing 14 is directed through the lower chamber 136, the upper chamber 134 can be used to contain other elements such as diagnostic or communication equipment or back up power supplies. Alternatively, to assist with the draw of air through the lower filters 154 installed in additional cartridge filtration chamber housings 18, the upper chamber 134 may be modified to include an additional fan 66 or pressurisation fan 168.

It should be further appreciated by the person skilled in the art that the above invention is not limited to the embodiments described. In particular, the following modifications and improvements may be made without departing from the scope of the present invention:
While the modularised housing has significant advantages to the invention in that it allows for easy repair and maintenance of all aspects of the air pressuriser, the invention can just as easily be supplied in a non-modularised housing.
The fan 66 may be omitted in favour of a vacuum port, the vacuum port being an outlet for a device that is operable to create a vacuum suction force in the air exhaust chamber 46.
The upper filter 148 may be any sort of filter including a HEPA filter, a SO₄ filter or a CO₂ filter. In its preferred arrangement, however, the upper filter 148 is a HEPA filter.
The lower filter 154 may be any sort of filter including a HEPA filter, a SO₄ filter or a CO₂ filter. There is no preferred type of filter for the lower filter 154.
The pressuriser may include a range of sensors that measure and monitor the current operation of the various components (such as, for example, the fan 66, air speed within the unit, etc.). These sensors may provide the measured data and/or diagnostic information back to a desired data collection point either through a data channel that follows alongside the mating electrical connectors or by way of a wireless communication system.
In one particular variation, the fan 66 is connected to a fan controller. The fan controller controls the operational speed of the fan 66.
In a further variation incorporating a fan controller, the fan controller is in data communication with either a temperature sensor or an air flow sensor or both. The fan controller operatable to adjust the speed of the fan 66 based on the measurements received from the temperature sensor and/or air flow sensor.
The airflow apertures in the blocking wall 68 may be flared to also create a bell mouth configuration.
The filters 76 may incorporate a closure mechanism. The closure mechanism may be manually operated or automatic. When the closure mechanism is set to a closed state, air is unable to be drawn through that filter 76.
The funnel rings 28 may be omitted.
The mating electrical connectors may be omitted in favour of a stored electrical power system, such as a battery. In a further alternative configuration, mating electrical connectors may operate to supply electrical power that is used to recharge the battery, with the battery providing electrical power to the fan 66.
Means of securing separate housings together other than the bolt and bolt recess combination described may be used without departing from the scope of the present invention.
The identification plate 40 may be omitted. Omission of the identification plate 40 is particularly suitable in situations where the air pressuriser 10 has been modified to facilitate wireless communication of diagnostic information (where an identifier for the air pressuriser 10 will be supplied as part of the diagnostic information).
The air pressuriser may use other locks 120 to that described above. For instance, the locks 120 may be replaced with over centre latches or cam locks that act to securely connect the mid-plate 16 to the cartridge filtration chamber housing 18.
Other fan mounting structures may be used beyond those described above. For instance, the fan 66 may be clamped or physically connected to elements to retain it as a divider between the air exhaust chamber 46 and the cyclonic filtration chamber 44.
The air pressuriser 10 may use other mechanisms to facilitate its mounting beyond the mounting recesses 146.
The system may further include separate sensors to measure both the interior and ambient CO₂ levels.
While the invention has been described in the context of cylindrical filters and associated chambers, it is to be appreciated that other filters (and by association chambers) of differing shapes may be used.

It should be further appreciated by the person skilled in the art that the invention is not limited to the embodiments described above. Additions or modifications described, where not mutually exclusive, can be combined to form yet further embodiments that are considered to be within the scope of the present invention.

1. An air pressuriser comprising:
at least one centrifugal separator having a filtered air exhaust port and a filtered particle exhaust port;
at least one filter;
a suction device; and
a pressurisation fan,
where each of the aforementioned components is housed in at least one housing and where the pressurisation fan is operable to apply a suction force to the filtered air exhaust port by way of at least one of the at least one filters and the suction device operable to apply a suction force to the filtered particle exhaust port, the amount of suction force being applied to the filtered particle exhaust port being at least of sufficient force to compensate for any difference between the velocity of air flow passing through the at least one centrifugal separator and the velocity of air flow required by the at least one centrifugal separator to effect centrifugal separation of particles from the air flow.

2. An air pressuriser according to claim 1, where the at least one centrifugal separator and the suction device is located in a first housing connected to, but separable from, the housing, or housings, in which the at least one filter and pressurization fan are housed.

3-33. (canceled)

34. An air pressuriser according to claim 1, where the first housing is divided into an upper chamber and a lower chamber, the at least one centrifugal separator being located in the upper chamber and the interior of the upper chamber having at least one angled wall to funnel particles separated by the at least one centrifugal separator to the lower chamber.

35. An air pressuriser according to claim 2, where a mounting structure further operates to divide the upper chamber from the lower chamber, the vacuum source being maintained in its desired position with the first source by way of the mounting structure.

36. An air pressuriser according to claim 2, where the at least one filter is located in a second housing connected to, but separable from, the remaining housings, and where the second housing has a dividing wall that divides the second housing into an upper chamber and a lower chamber and where the upper chamber, in cross-section, being of different shape to the lower chamber.

37. An air pressuriser according to claim 36, where the lower chamber is sized so as to receive a portion of a lower cylindrical filter having a first flange about its periphery, the first flange spaced from an end of the lower cylindrical filter, the cross-sectional shape of the first flange being substantially identical to the cross-sectional shape of the lower chamber.

38. An air pressuriser according to claim 36, where the upper chamber is sized so as to receive a portion of an upper cylindrical filter having a second flange about its periphery at a first end of the upper cylindrical filter, the cross-sectional shape of the second flange being substantially identical to the cross-sectional shape of the upper chamber.

39. An air pressuriser according to claim 2, where the pressuriser is located in a third housing connected to, but separable from, the remaining housings, and where the third housing has an upper circular aperture and a lower circular aperture, the pressuriser being received within the third housing by way of the lower circular aperture.

40. An air pressuriser according to claim 39, where a scroll wall surrounds a portion of the periphery of the lower circular aperture, the scroll wall deflecting at one end towards the upper circular aperture.

41. An air pressuriser according to claim 40, further including a mid-plate, the mid-plate connected to, but separable from, the first housing, and where the mid plate has a first circular aperture for receiving a portion of the lower cylindrical filter including the end and where the interior of the mid-plate defines a conduit between the filtered air exhaust port and the lower cylindrical filter.

42. An air pressuriser according to claim 2, where each housing has at least one electrical connection, each electrical connection able to matedly connect with the electrical connection of its adjacent housings so as to provide a power source for the suction device.

43. An air pressuriser according to claim 2, where each housing is connected to its adjacent housings by way of a locking arrangement comprising a pivotable locking arm and a lug.

44. An air pressuriser according to claim 41, where the upper cylindrical filter is a HEPA filter and/or the lower cylindrical filter is one of the following: a HEPA filter; a SO₄ filter; a CO₂ filter.

45. A method of pressurising air comprising the steps of:
applying a suction force generated by a pressurisation fan to a filtered air exhaust port of at least one centrifugal separator, the suction force being applied to the filtered air exhaust port by way of at least one filter;
applying a suction force generated by a suction device to a filtered particle exhaust port of the at least one centrifugal separator; and
ensuring that the amount of suction force generated by the suction device to the filtered particle exhaust port is sufficient to compensate for any difference between the velocity of air flow passing through the at least one centrifugal separator and the velocity of air flow required by the at least one centrifugal separator to effect centrifugal separation of particles from the air flow.

46. A method of pressurising air according to claim 45 further comprising the steps of:
funnelling the particles separated by the at least one centrifugal separator to a lower chamber of a first housing in which the at least one centrifugal separator and the suction device are located; and
expelling the particles from the first housing by way of exhaust vents.

47. A method of pressurising air according to claim 46 where the exhaust vents are located in the bottom and at least one side of the lower chamber.

48. A method of pressurising air according to claim 45, where the suction device is a conduit leading to a vacuum source.

49. A method of pressurising air according to claim 45, where the vacuum source is a fan.

50. A method of pressurising air according to claim 49, further comprising the step of controlling the speed of the fan.

51. A method of pressurising air according to claim 50, further comprising the step of measuring the atmospheric temperature and setting the speed of the fan based on the atmospheric temperature measurement.
